(19) United States
(12) Patent Application Publication
(10) Pub. No.: US 2012/0295219 A1
(43) Pub. Date: Nov. 22, 2012

(54) DENTAL ARTICULATOR FOR POSITIONING THE ARCADES WITHOUT THE USE OF PLASTER

(76) Inventors: Jorge Avelino Monteiro Geras, Santana de Parnaiba (BR); Edeli De Mare, Santana de Parnaiba (BR)

(21) Appl. No.: 13/502,245

(22) PCT Filed: Jul. 26, 2010
(86) PCT No.: PCT/IB2010/053391

§ 371 Date: Aug. 3, 2012

(30) Foreign Application Priority Data
Oct. 14, 2009 (BR) PI0904212-1

(51) Int. Cl. A61C 11/08

(52) U.S. Cl. 433/55

(57) ABSTRACT

This patent application refers to a mechanical equipment that, when used in conjunction with a device to determine the position of the superior arcade of the patient, based on landmarks on the skull of the same, allows accurate reproduction of the position of the dental arches, represented by plaster models and simulation of mandibular movements. These models are connected to the equipment, through a unique positioning mechanical system, eliminating the use of plaster to fix the same. The patent, now required, includes features of the equipment currently called “articulator” and “face-bow” and adds new features in an unprecedented and innovative way. The set of the equipment is light weighted, and easy to handle, allowing up to 50% reduction in the time required for assembly and adjustments when compared to the equipment market, and its guide system makes the reproduction of mandibular movements very accurate, avoiding errors in diagnosis and treatment.

This patent application refers to a mechanical equipment that, when used in conjunction with a device to determine the position of the superior arcade of the patient, based on landmarks on the skull of the same, allows accurate reproduction of the position of the dental arches, represented by plaster models and simulation of mandibular movements. These models are connected to the equipment, through a unique positioning mechanical system, eliminating the use of plaster to fix the same.

The invention, now required, includes features of the equipment currently called “articulator” and “face-bow” and adds new features in an unprecedented and innovative way.

The set of the equipment presented in this patent application is light weighted, and for its simplicity, its cost may be lower than any of the equipment with equivalent functionality on the market.

The total process time can be reduced by up to 50%, depending on the ease of handling. Its guide system makes the reproduction of mandibular movements very accurate, avoiding errors in diagnosis and treatment.

In this way, we eliminate the barriers that make the current equipment being less used, obtaining relevant gains in time and cost and greater flexibility in scope and possibilities of study and planning dental treatment.

### PRIOR ART

There are, in the current state of the art, various appliances and equipments used in dental treatment within the same scope of the present invention.

We can cite, for example, U.S. Pat. No. 7,048,539 which refers to an anatomical protractor bow, with the aim to take the correct position of the arcade of the patient in relation to the skull base to the articulator, using the anatomical points of reference.

U.S. Pat. No. 6,109,917 refers to a dental device that determines a specific aesthetic reference plane for mounting the patient's teeth. The device includes a face-bow, a relational set nose, a level gauge and a bite fork.

U.S. Pat. No. 5,632,619 refers to a face-bow for receiving and transferring an arcade model to an articulator, in the correct spatial orientation on the skull of a patient and the axis of temporomandibular joint. The face-bow transfer element has a curved face to engage the patient and a guide column pivoted to the transferring element, to support an adjustable bite fork. The transfer element has an elongated groove centering guide and the column has an adjustable projection, which is perpendicular to the column guide to fit the slot centering.

U.S. Pat. No. 5,090,901 refers to a support with a vertical column, to hold a face-bow, a bite fork with moldable material to obtain the impressions of the cusps of the teeth of the patient, elements plug headset to be positioned in to the patient's ears, and an indicator of fit the lips. The face-bow can be removed from the support and adapted to an articulator.

The patent application BR 8502218-7 refers to a device with three-dimensional adjustment system for quick fixing of plaster models on a dental articulator that already exists on the market.

### DESCRIPTION OF THE PRIOR ART

### Articulators

The first researchers who noticed the importance of knowledge of the dynamic of TMJ (temporomandibular joint) and mandibular movements in occlusion, understood the need to create a device that could simulate the TMJs function, position the plaster models and reproduce the mandibular movements on a satisfactory occlusion.

The articulator is a mechanical instrument that represents the temporomandibular joint, and superior and inferior maxillary arcades, represented by plaster models. The articulator records the inter-maxillary relations and the mandibular activity is reproduced by the movement of the upper arm.

The articulator is one of the most important instruments used by the dentist, when treating their patients, being used with three primary goals:
Correct establishment of the diagnosis of clinical case.
Development of an effective treatment.
Accurate construction of elements for treatment.

The articulator may be: Non-adjustable, Semi-Fully-adjustable or fully-adjustable.

The Non-adjustable articulators, called “hinges” are considered the simplest instruments, allowing only the opening movement and arbitrary closure, preventing, for example, the eccentric mandibular movements. The occlusion limitations of the equipment requires, from the professional, to spend considerable time adjusting the prosthetics elements of treatment installed in the patient, until they are free from interferences. Another limitation is the impossibility of using the face-bow for any of these instruments. This type of articulator is responsible for many problems related to prosthetic occlusal interferences, which result in injury to the patient's stomatognathic system.

The Semi-adjustable articulators are designed to replicate some mandibular movements, supporting the diagnosis, treatment planning and the manufacturing of various components of treatment, allowing, usually, three types of adjustment: inter-condylar distance, condylar trajectory and Bennet angle.

Several studies and authors have demonstrated that the semi-adjustable articulators, when used correctly, are very useful in daily practice, reducing the time of many clinical procedures as a result of good planning. Standard angles can also be useful in reducing the whole time procedure.

The Fully-adjustable articulator, which provides more precision in reproduction of mandibular movements, have more complex systems, and are indicated for cases of great specificity. Its technical difficulty of handling and high cost of equipment causes them to be less used.

### Face-bow

The face-bow is an instrument used to record the spatial position of the patient's superior dental arch in relation to the skull and to transfer this registration to the articulator.

### Use

For the correct use of the set composed of articulator and face-bow, the following steps must be observed:
1) Getting the print of the arches by using an appropriate dental tray and material (hydrocolloid or silicone), held in the clinical procedure during which it is also taken the bite impression in centric relation (the most posterior position of the mandible related to the joint (TMJ)) on a wax plate. For proper results it is necessary a clinical time estimated at approximately 30 minutes.
2) Manipulating the plaster mass and filling the cast obtained during the clinic session. This procedure is performed without the presence of the patient and requires about 10 minutes of manipulation and more about 30 minutes to wait for the plaster to harden. After that, the model is prepared (cut and hydrated) to be mounted at the articulator.
3) Getting the reference position with the face-bow to transfer it to the articulator. There are some models of face-bow. Just for illustration, it will be described the procedure for the pattern most widely used:
The material used to obtain the marks of the incisal tips of the cusps of upper teeth has to be manipulated and placed over the fork. These marks will be used as a guide for the placement of the plaster model of the superior arch to the articulator. After the fork is placed in the mouth, it is connected to the bow. This must be correctly positioned by placing the right and left devices in the ears of the patient. For correct alignment with the Frankfurt plane (a plane of reference widely used in dentistry), it is necessary to immobilize the bow, through the positioning of a third point which rests just above the nose and locking all articulated mechanisms of the system. After that, the bow must be carefully opened, so it can be removed from the patient and transferred to the articulator.
This clinical procedure may generate some uncomfortable sensation to the patient by the insertion of those devices in the ears, the stiffness of the equipment and the need for the patient to be still for several minutes in order to obtain the correct reference position. The complexity of the method can also compromise the accuracy of the result. It is estimated about a 30 minutes clinical time to perform the entire process.
4) The plaster models must be set up to the articulator. The process by assembling the face-bow to the main axis of the articulator is made through pins in the upper side of the articulator. Then, the model obtained from the superior arch is positioned according to the marks in the impression material on the fork. The space between the model and the upper arm of the articulator is filled with the mass of plaster. This step requires an estimated time of 30 minutes for execution.
5) After the plaster hardens, the procedure of mounting the inferior model begins. To do so, the face-bow positioner must be removed and the articulator must be turned upside down. Then, the inferior plaster model is placed over the top of the superior, according to the occlusion defined by the wax bite obtained in the first clinical phase. The procedure of filling the space between the model and the lower arm of the articulator with plaster is repeated. It's estimated that 30 minutes are necessary to realize this process.
6) The volume of the mass of plaster may vary after it hardens. It is also possible to take place a little distortion of the position of the model relative to the initial reference. To avoid this drawback, the professional often chooses to insert a minimum quantity of plaster, initially, waiting for the material to harden first and then he fills in the rest of material necessary to guarantee the strength of the base. This procedure involves extra work time of about 20 minutes.
7) For the correct reproduction of the mandibular movements by the equipment, some adjustments of the inclination of the condylar guides and the devices that determine the angle of Bennett, responsible for spatial positioning of the mandible during lateral excursions, have to be done.
8) The adjustment of the condylar trajectory is done by positioning the models according to the impressions of the tips of cusps in a wax plate obtained clinically with the patient in a situation of mandibular protrusion. With the models in this position, it appears a distance between the spheres in fixed vertical ends of the inferior branch of the articulator, corresponding to the mandibular condyles and the upper walls of the set of tabs on the top branch. These walls must be leaned until they return to play in the balls. Its determined, in this way, the slope of the condylar trajectory of the patient to serve as a guide for reproducing the motion of mandibular protrusion.
9) To adjust the lateral movement of the mandible, the plaster models must be positioned in accordance to the wax bite which reproduces the relationship between the cusps of the teeth in maximum lateral position of the patient to one side and then, to another. The bite corresponding to the movement to the left determines a distance between the ball on the right side and the side wall of the upper guide on this side. This wall must be moved until it touches the ball, thereby determining the angle of Bennett, responsible for spatial positioning of the mandible in laterality. The procedure is repeated to the other side.

The complexity of current equipment creates a barrier to its use by dentists in their daily clinic. The process requires the handling of plaster for positioning the models (with the inaccuracies and difficulties of hardening time and the impossibility of changing the position) and it is uncomfortable to the patient. It requires a great assembly time, since the use of face-bow, filling casts, and mounting to the articulator until its use for treatment planning. The total time of the process may reach approximately 4 hours, generating a high cost to patients and dental professionals.

Another common problem is the inaccuracy of motion reproduction, because the upper branch must be handled by the professionals and can easily slide over the platforms guides, or even be detached from the inferior branch which could interfere in the final movement.

Additionally, the current devices are heavy weighted and with average purchase price very high.

We understand that a large proportion of dental professionals do not use these equipments because of those barriers, decreasing the quality of study and treatment.

### DISADVANTAGES OF THE PRIOR ART EQUIPMENTS

Necessity of using plaster for mounting models on the articulator and occurrence of distortions due to contraction or expansion of plaster, which in some cases determines the necessity of doing all the work again.
The use of plaster does not allow repositioning (static position—fixed by plaster).
Compromising visualization of the entire process and allowance of unwanted movement of the upper arm during its handling, interfering with the final work due to simulation of mandibular movement is accomplished by moving the top branch.
Difficulty and complexity of handling the equipment.
High cost of the product.
Difficulty of handling the device called the face-bow by the dentist and the use of it by the patient.

### OBJECTIVE OF THE INVENTION

In order to solve the disadvantages of the current prior art equipment as currently called “articulator” and “face-bow”, the present invention has the following features:
Translate the relationship between arches (superior and inferior) through a mechanical system for positioning and repositioning the models by eliminating the use of plaster for this purpose.
Simulate mandibular movements through rail system and guide pin providing precision movement.
Simulate mandibular repositioning providing background to study and planning of patient treatment.
Simulate mandibular movements by moving the lower arm, playing with greater fidelity and ease the dynamics of human mastication.

The patent application covers the functions of the equipments currently called “articulator” and “face-bow”, adding new functionality in an unprecedented and innovative way.

The set of equipment presented is light weighted, and for its simplicity, its cost may be lower than any of the equipment with equivalent functionality on the market.

The total lead time can be reduced by up to 50% related of the ease handling and does not wasting time to wait plaster harden.

In this way, we eliminate the barriers that make the current equipment, being less used, obtaining relevant gains in time and cost and greater flexibility in scope and possibilities of study and planning dental treatment.

### BRIEF DESCRIPTION OF FIGURES

FIG. 1 illustrates the equipment, object of the present application, in a perspective view partially exploded;

FIG. 2 illustrates the basic equipment, object of the present application in a plan view;

FIG. 3 shows the base of the equipment (12) in a perspective view;

FIG. 4 shows details of all the tilting sets of the equipment, subject of this application;

FIG. 5 illustrates the use of the protractor (4) for taking the coordinates of reference;

FIG. 6 shows the device, object of the present application, in a sectional side view, when it is made the introduction of bite fork;

FIG. 7 shows a sectional side view by the time the placement of dental models in relation to the bite fork is done;

FIG. 8 shows a sectional side view, by the time at which the withdrawal of bite fork is made;

FIG. 9 shows a sectional side view, with the repositioning of plaster models of the arches, without the fork;

FIG. 10 shows a sectional side view, with the simulated movement of opening and closing of the superior model, relative to inferior model;

FIG. 11 shows the firing spring (100) to promote detachment of the superior and inferior dental arches;

FIG. 12 shows a sectional side view, with the simulated movement of the inferior model forward, through the movement of the arm movement (9);

FIG. 13 shows the top view of FIG. 11;

FIG. 14 shows the top view of FIG. 12, and

FIG. 15 shows the top view of the lateral movement of the inferior arcade.

### DETAILED DESCRIPTION OF THE INVENTION

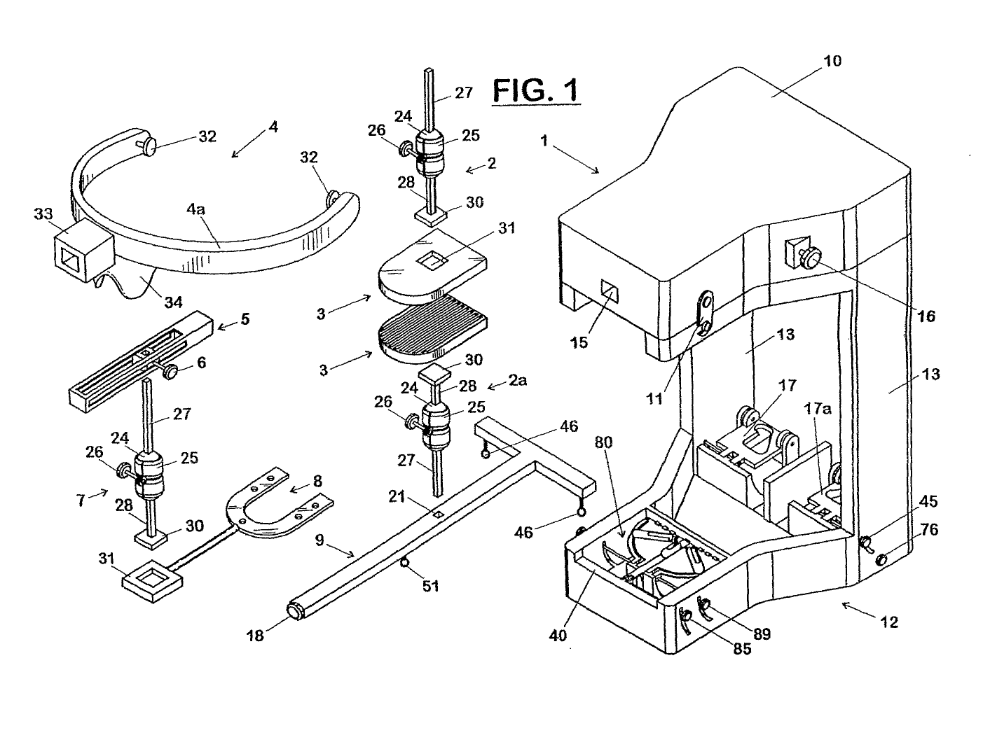

According to FIG. 1, the equipment for positioning and repositioning the arcades, which allows the simulation of mandibular movement, comprises a support structure (1), superior structure (2) and inferior structure (2a) sets of positioning/repositioning the models, sets of tilting (17,17a), set of lateral-frontal movement (80) of the arm, arm movement (9), support plates for plaster models of the arcades (3), protractor (4), horizontal rod (5), a set of positioning/repositioning of the arc (7) and stem with nipper (8).

The support structure (1) comprises a cover (10), supported by two lateral structures (13), which in turn are supported across the lower base (12). The whole set of the lower base (12) comprises means for moving the inferior arcade which will be explained in details later.

This support structure (1) has all its surfaces opened, facilitating the visualization during the manipulation of the arm. The cover (10) has a prismatic quadrangular fₒᵣmat with a hollow structure and it is fixed in the supporting structure(1), through a hinge with removable pins (14), placed in the rear, which allows its opening or closing movements, or the removal of the cover (10), by removing the pins of it. A notch (15) is located in the front of the cover (10) for receiving the horizontal rod (5) of the protractor (4). The spin button (16) for locking the vertical movement of the superior positioning/repositioning set (2) is located in the right lateral surface. A latch (11) is disposed on the right side of the cover (10) to allow the locking of it on the same support structure (1).

The base (12), has a prismatic quadrangular format, and is connected to the upper portion of the support structure (1), through its lateral structures (13). There is a fillister (40) in front of the base (12) of the support structure (1) through which the arm movement (9) is positioned.

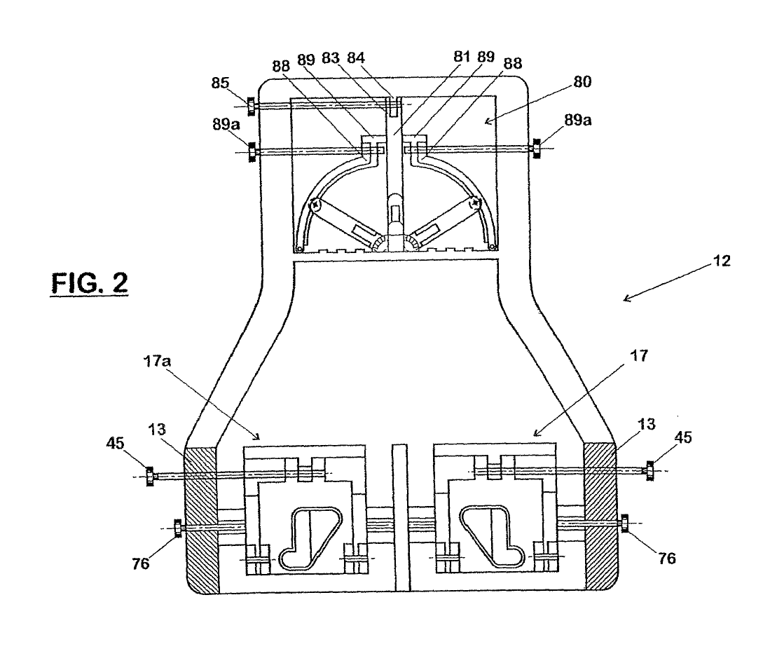

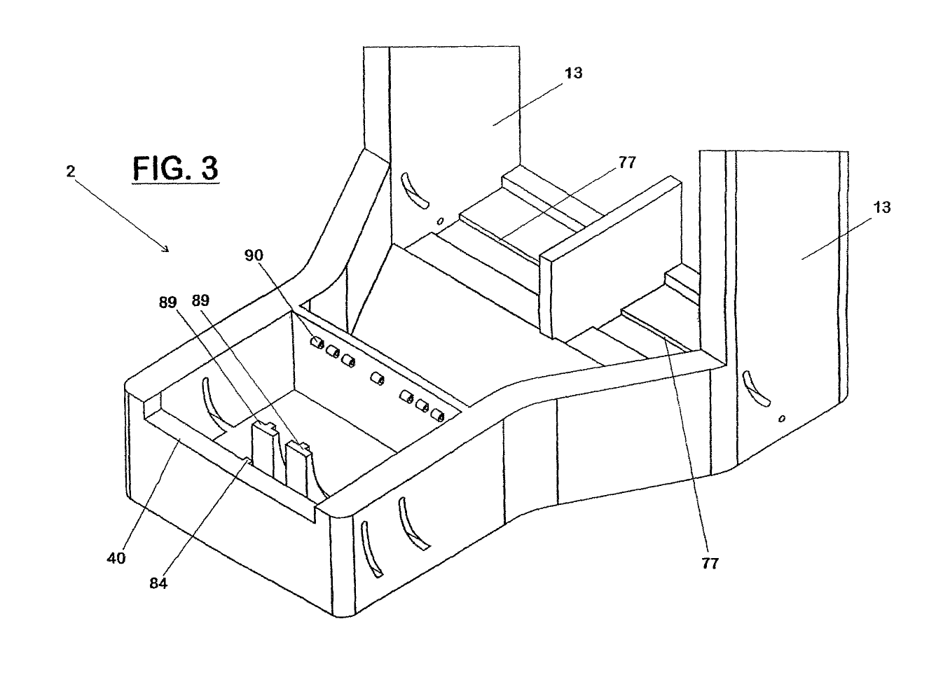

As seen in detail in FIG. 2, in the back side of the base (12), are located the two tilting sets, left (17) and right (17a), which are intended to allow an inclination motion of the arm movement (9), and to be a guide to lateral movement.

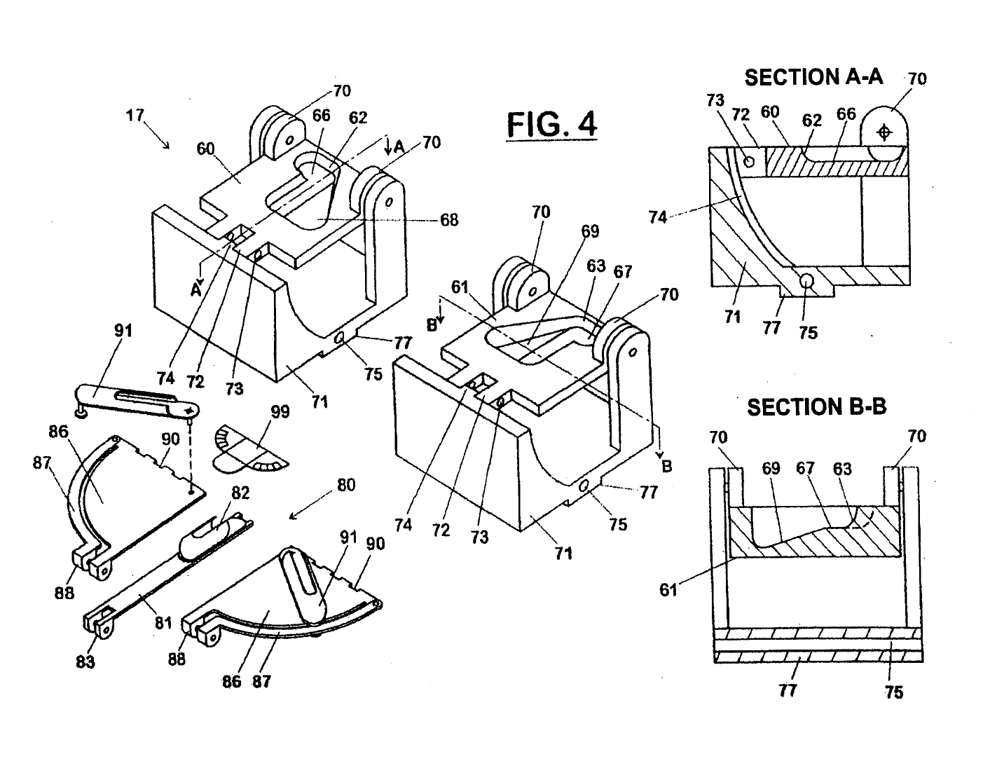

In these tilting sets (17, 17a), shown in detail in FIG. 4, there are plaques (60, 61) with recesses (62, 63). The bottom of the mentioned recesses (62, 63) has a flat part (66, 67) and an inclined ramp-shaped portion (68, 69). The rectangular plates (60, 61) have mounting tabs (70), articulated at support bases (71). In front of the rectangular plates (60, 61), there are two tooth-shaped protrusions (72) with threaded holes (73). The aforementioned projections (72) are guided by a protuberance (74) on the front of the support base (71). The tilting movement of the plates (60,61) is controlled by the screw (45) located on the lower lateral side of the base (12), while they slide along those projections (72), as seen in FIG. 1. The support base (71) also has threaded holes (75) at its center, through which a screw is set to adjust the lateral movement (76) (FIG. 1) of the tilting sets (to 17.17). This lateral movement is guided through a slit (77), placed at the bottom of the support base (71), and there are numerical markings along it to record this position.

In the front of the base (12) there is the mechanism for the lateral-frontal movement (80) of the inferior arcade (FIG. 1).

As shown in FIG. 4, the set for lateral-frontal motion (80) comprises a central guide (81) formed by an elongated strip, with a guide plate in its rear (82) which form a rail to guide the slip arm movement (9) in the longitudinal angle. The central guide (81) has two tabs on the front end (83) with threaded holes. These tabs (83) slide on a ledge (84) arranged in front of the base (12) which can be locked by screw (85). Along the crack traveled by the screw (85) are numerical markings for reference angular position of the center tab.

The set for lateral-frontal motion (80) also has two side plates (86) in the form of a quarter circle. These plates have an indentation (87) that accompanies the circular edge and ends at the front of the plate in the form of two flaps (88) with threaded holes and, following the indentation, there are markings corresponding to the angles between 0-90 degrees. These flaps (88) slides through protruding tabs (89) arranged in front of the base (12), and has its sliding motion controlled by screws (89a) (FIG. 2). This sliding motion causes a tilting movement of the plates (86) around an axis through the hinges (90), located at the rear of the plate (86), and is attached to the base (12). Along the slit traversed by the screw (89), there are numerical markings for reference of this movement.

On the side plates (86), also slide plate guides (91) through the indentations (87), around the axis located at the apex of the side plates (86). A connection platform (99) provides the union between the plate guides (82.91).

Such disposal of the guide plates (91), sliding on the side plates (86), allows the lateral angular displacement of the arm movement (9).

The arm movement (9) has its structure in a “T” shaped form. The longer part is combined with a screw (23) with a head shaped as a knurled knob (18). In the body of the longest part, is a square hole (21) to receive the rod (27) of the positioning/repositioning set (2a), which is attached by tightening the screw (23). On the other side, stands a pin (51) with a ball on its end that is intended to be coupled in the guide plates (82, 91). At the perpendicular direction of the “T” shaped structure, there are protruding pins (46), with balls at their ends, to be embedded in the recesses (62, 63). The pin (51) rests on a spring (100) to allow a small displacement of the inferior arcade by pressing the arm movement (9).

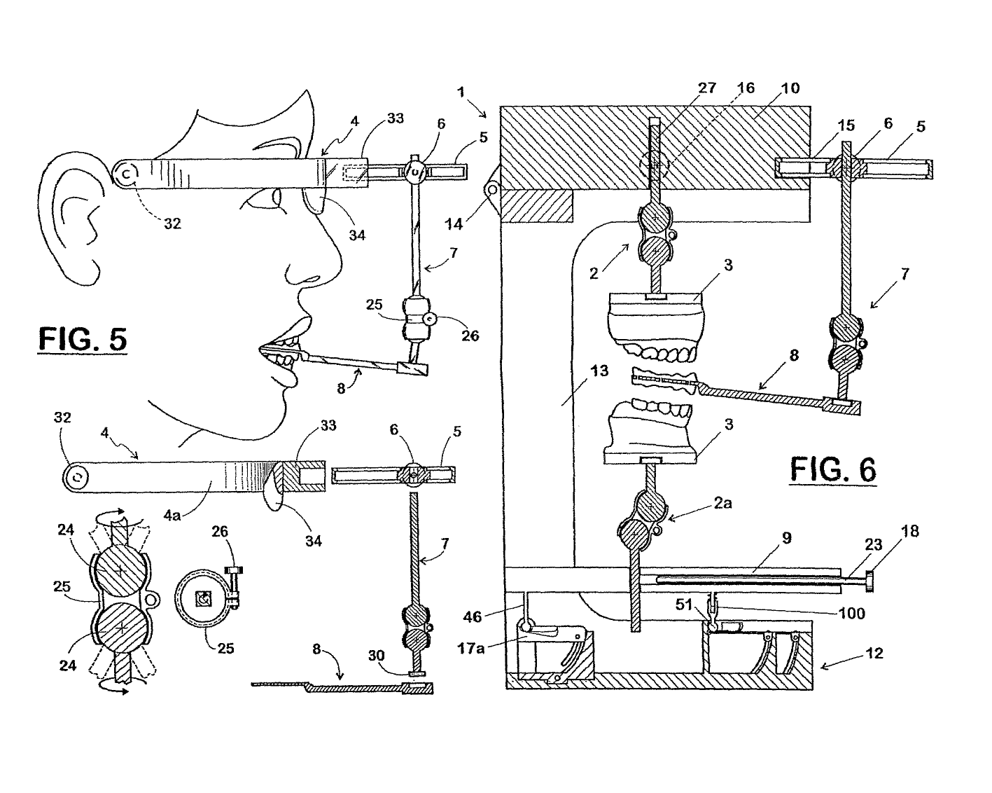

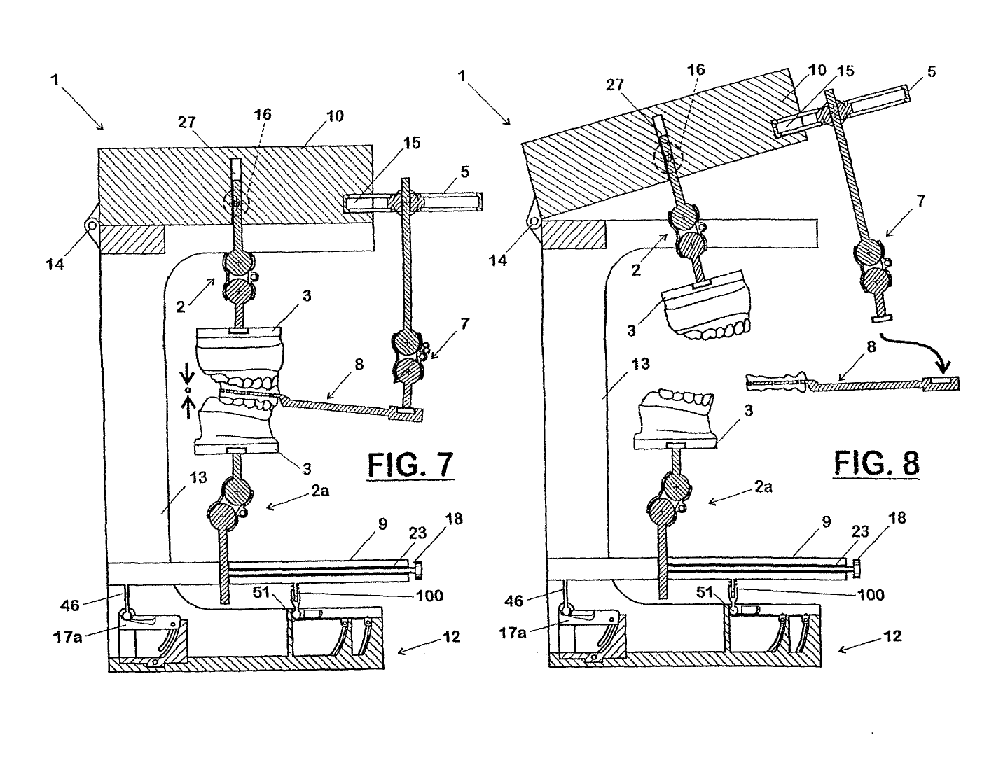

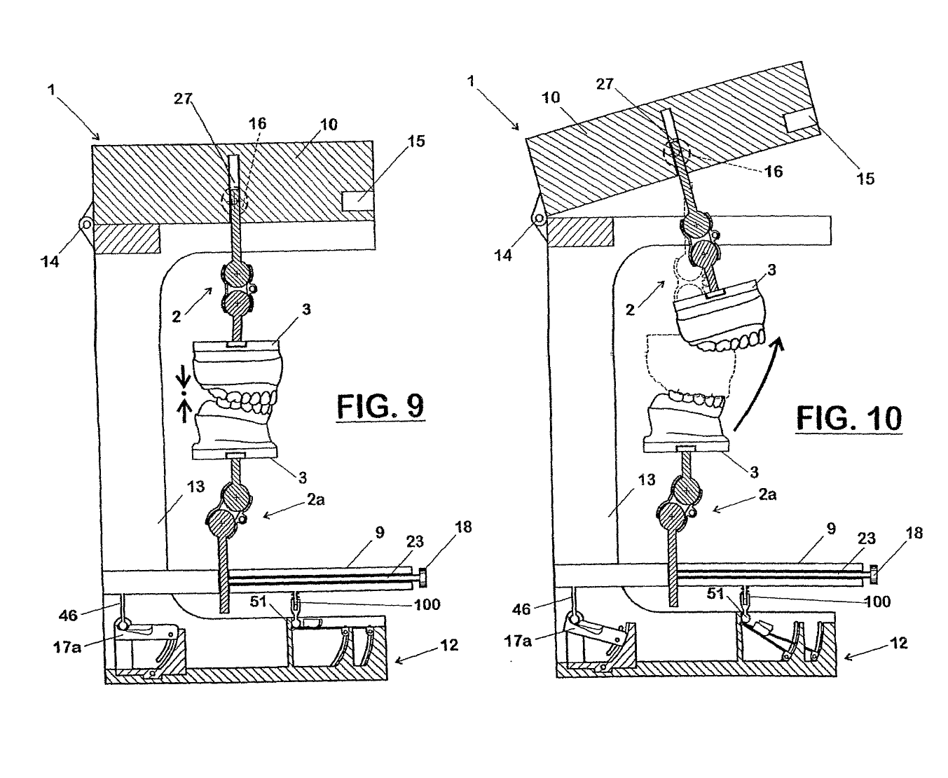

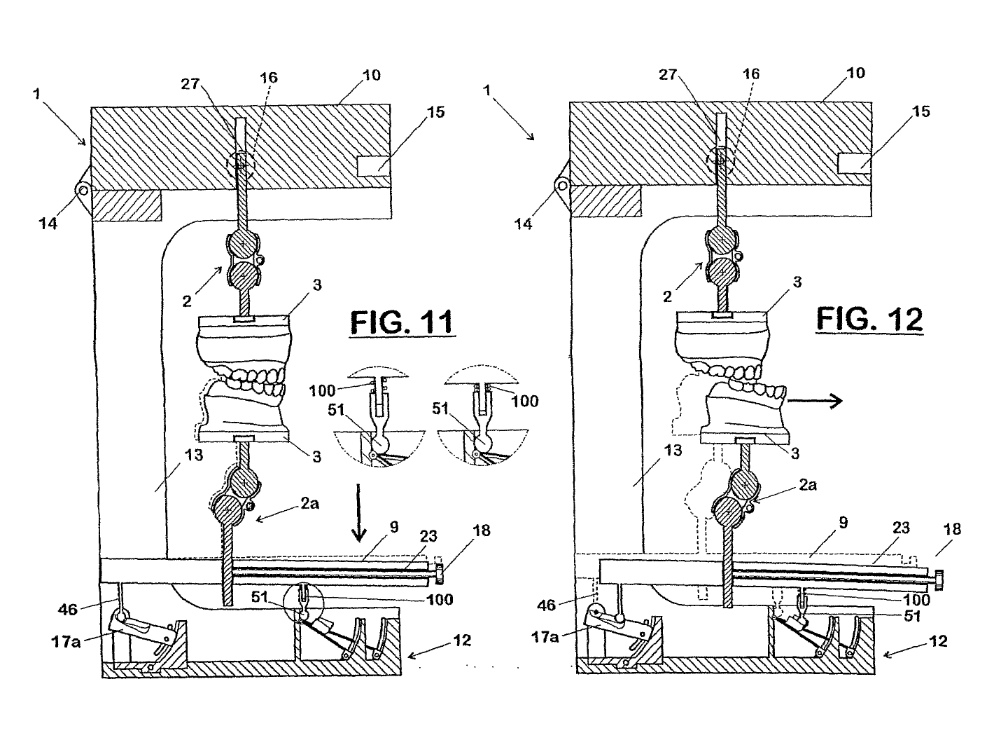

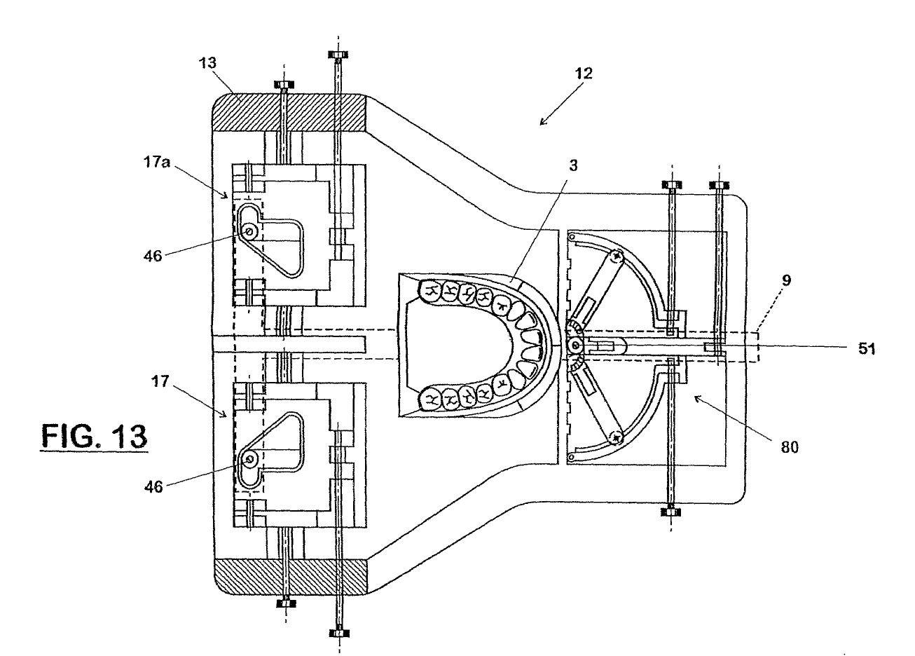

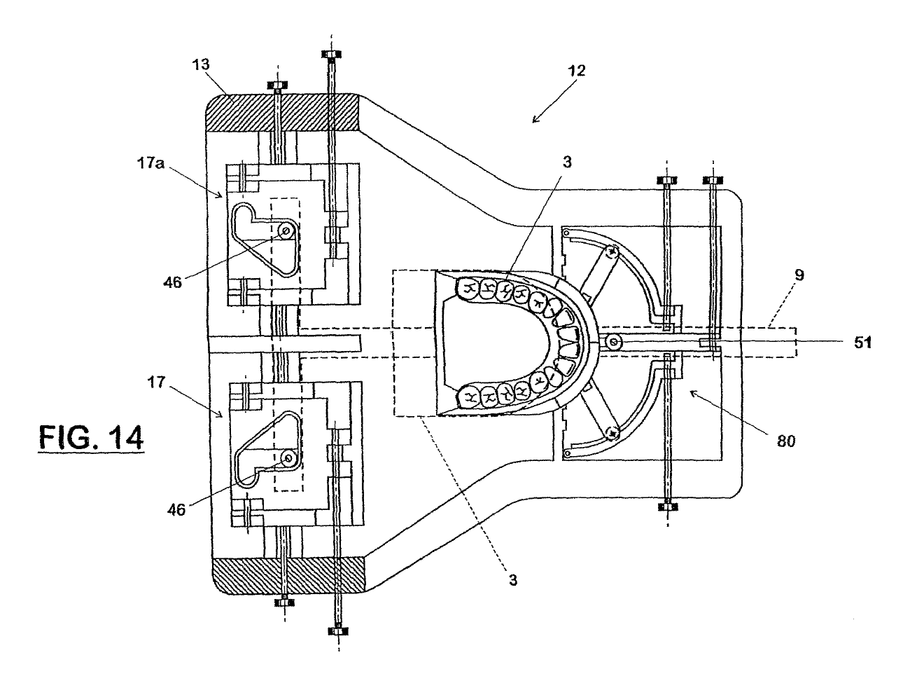

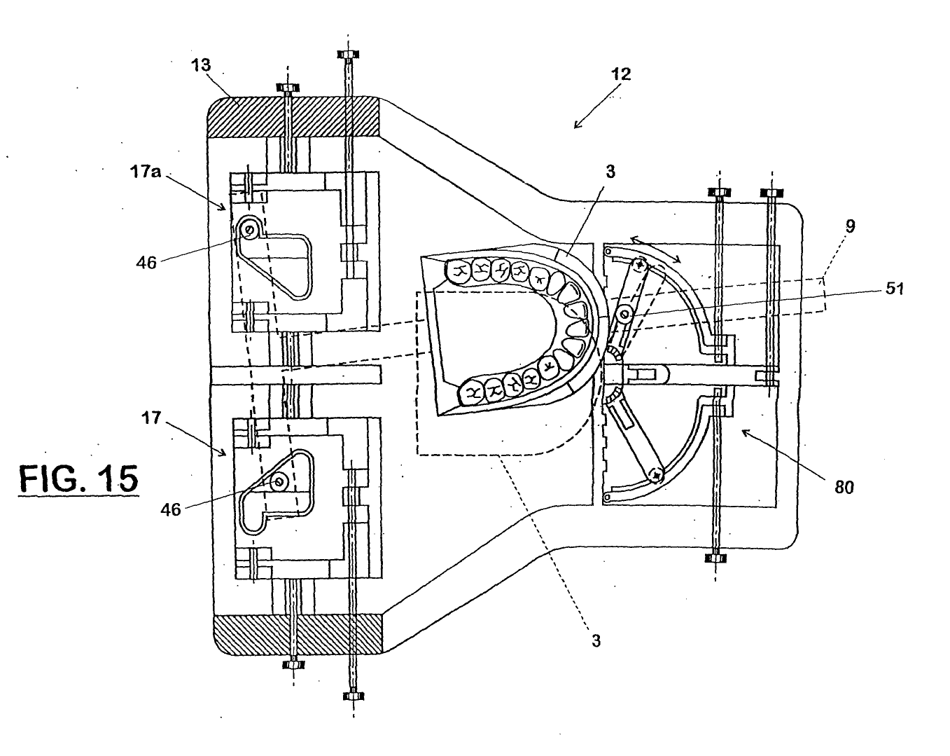

It is observed in FIGS. 1, 5 and 6 that the superior and inferior positioning/repositioning sets (2, 2a) comprise a set of two balls (24) encapsulated in a vertical cylindrical enclosure (25) which embraces the two spheres (24), exposing half of each, one on its upper portion and the other on its lower portion, allowing it to spin freely, without loosening. This receptacle is a vertical cylinder (25) with a semi-open slit which, through a locking device (26) with a screw, prevents the rotation of the spheres. One of the spheres has a fixture like as rod with threaded tip (27), which allows its connection to the cover (10) of the support structure (1) or to the arm movement (9) through their respective locking elements. In one surface of this rod (27), there is a marking like a ruler for position reference. The other ball is fixed to a small rod (28) which serves as a union mechanism between it and a rectangular magnet (30).

The connector base of the plaster model is semi-oval shaped plate (3) with a rectangular cavity (31) with metal cladding and the dimensions needed to fit the magnet (30) system positioning. On its other face(the surface is composed of slots.

The protractor assembly (4) to the reference position comprises a flexible arch (4a) with rubber tips (32) at its ends and at its center stands one block (33) of rectangular shape which has a slot in the front side and under it, a nosepiece (34), consisting of an element in soft material with the anatomical shape to the human nose.

The horizontal rod (5) consists of a hollow prismatic bar, with a locking element (6) running through it. The horizontal rod (5) has scale markings engraved into their faces all along its surface.

The locking element (6) slides into the hollow interior of the horizontal rod (5). It has a prismatic shape with a threaded hole in its side in the horizontal plane. In the vertical plane has a square hole, to collect the positioning/repositioning set of the arc (7) which rod is locked by a screw.

The positioning/repositioning set of the arc (7) is similar to the superior and inferior positioning/repositioning set to the models (2, 2a). It consists of a set of two balls (24), encapsulated in a vertical cylindrical enclosure (25) which embraces the two spheres (24), exposing half of one in its upper portion and the other one on its lower portion, allowing them to slip freely without loosening. This receptacle has a slit (semi-open) that by a locking device (26) prevents the rotation of the spheres (24).

One of the balls (24) has a fixture like a rod with a threaded tip (27), which passes through the locking element (6). On one surface of the rod there is a marking, like a ruler for position reference. The other ball is fixed to a small rod that serves as a mechanism of union between it and a rectangular magnet (30).

The rod with a bite fork (8) is a rectangular stem with one end in a shape of a rectangular cavity (31) with the necessary dimensions for the coupling with the magnet (30) of the rod of positioning/repositioning set. At the other end of the stem there is an element in the shape of a dental arch on which the impression material, like wax or similar is set.

### METHOD OF USE

Functionality

This equipment is designed to reproduce the relationship between the superior and inferior dental arches, and the axis that crosses through the temporomandibular joints, which are responsible for all chewing and swallowing movements and phonation. The horizontal plane crossing the base cover (10) and the hinges with removable pins (14) of the equipment corresponds to a reference plane called the Frankfurt plane.

To initiate the process, the impression material is placed in the fork and is pressed against the superior teeth of the patient, obtaining this way, the marks of the cusps that will be used as reference to position the plaster model. The fork is held in position in the mouth while the spatial positioning system is coupled to it at its end.

The arc of the protractor (4) is then positioned in the patient, so that its edges with the rubber tips (32) touch the face in the region correspondent to the location of the TMJs.

The alignment of both ends is determined by a third point located in the anterior region of the face, just above the onset of nasal prominence where is upheld the support of the nose (34) present in the frontal region of arc (4).

At this time, the mechanism of the spatial position must be locked, by rotating the screw (26) of the receptacle (25) of the balls (24) and by locking the screw of the vertical rod (6), thereby determining a static position of superior arcade just to the reference plane, allowing the transfer of this position to the equipment.

The horizontal rod (5) of the protractor, that was embedded in the arc (4a) is detached and transferred to the device being inserted into a slot (15) provided for that purpose.

The plaster model of the superior arcade, which already contains the base connector (3), must be rested on the corresponding marks obtained in the impression material of the fork. The magnet (30) must be seated in the cradle connector (3) and the position of the vertical rod (27) and the system of spheres (24) are held and locked by means of corresponding screws (16, 26).

After the model is positioned, the horizontal rod (5) of the protractor (4) can be removed, allowing the positioning of the inferior model.

The wax plate which contains the marks of the patient bite (clinical step performed before the start of this whole procedure) is set to the superior arcade mounted in the equipment and the inferior model is now fit to it.

The inferior model, which already contains the base connector (3), is attached to the magnet (30) of bottom positioning system, adjusting the position of the vertical rod (27) and the system of spheres (24). Locking is accomplished by tightening the corresponding screws (18, 26).

The opening and closing movement of the arcades is played by opening the cover (10), which is allowed by the hinge pin (14).

The adjustment of the tilting sets (17, 17a) and the angulations of the central guide of the lateral-frontal motion set is made by relating the superior and inferior models to another wax plate, now with the record of the patient's bite in situations of mandibular protrusion. Under this condition the protruding pins (46) and the anterior guide pin (51) make the plates (60, 61) with recesses (62, 63) and the central guide (81) to be inclined forward.

These positions are locked by tightening the screws (45, 85).

The protrusion movement can now be played by making the arm movement (9) walk on the plates (60, 61) with recesses (62, 63) and the central guide (81) well adjusted.

The adjustment of the inclination of the side plates (86) and the plate guides (91) is done individually, first to the right side and then to the left.

To do so, a wax plate, with the marks reproducing the cusps of the superior and inferior teeth during the closure of the mandible under the most extremely lateral position is set to the superior model. Then, the inferior model is guided to the marks in the bottom of the wax plate by sliding arm movement (9). The ball of the pin (51) that is partially retained within the guide plate (91), leads the right movement of this plate and determines the lateral inclination of the plate (86). This movement is locked by tightening the screw (89), that is connected to side plate (86), threaded through the holes of the front flap (88).

To adjust the left side, the same sequence of procedures is repeated, by using the wax bite plate corresponding to this side.

After the final positions of the sets of tilting (17, 17a) and the set of lateral-frontal movement (80) are determined, it is possible to accurately reproduce protrusion and lateral mandibular movements by sliding the arm movement (9) on the plates (60,61) with recesses (62, 63) and the side guides plates (91) and Central plate(82);

To start the movement is necessary to make slight pressure on the spring (100) pin (51), on the anterior region of arm movement (9), allowing the spheres on the ends of protruding pins (46) to rotate about their own centers, promoting a slight detachment from the arcades, freeing the movement.

1. Dental articulator for positioning the arcades without the use of plaster, being characterized by a equipment that includes a support structure (1), a superior positioning/repositioning set (2) an inferior positioning/repositioning set (2a), tilting sets (17, 17a), a lateral-frontal motion set (80), arm movement (9), support plates of plaster models of the arches (3), protractor (4), horizontal rod (5), a positioning/repositioning set of the arc (7) and stem with bite fork (8), the support structure (1) comprises a cover (10), supported on two lateral structures (13) which in turn are supported throughout the lower base (12) and the whole of the lower base (12) comprises means for mandibular movement

2. The dental articulator according to claim 1, characterized by the support structure (1) with a cover (10), to be of a quadrangular prism shape of hollow structure, set in the support structure (1) through a hinge pin removable (14) disposed in the rear, and at the front surface of the cap (10) is located the notch (15), on the lateral surface is located the right button (16) for locking the vertical movement of the positioning/repositioning set and a lock (11) is disposed on the right side of the cover (10).

3. The dental articulator, according to claim 1, characterized by the support structure (1) to have a lower base (12) with slits on the sides where the locking screws may run (45, 85 and 89) and along of which there are numerical markings of reference.

4. The dental articulator, according to claim 1, characterized by two sets of tilting, one to the left (17) and one to the right (17a), having plates (60, 61) with recesses (62, 63), and the background of the aforementioned recesses (62, 63) have a flat part (66, 67) and an inclined portion shaped ramp (68, 69); the rectangular plates (60, 61) have mounting tabs (70), articulated to the base (71) on the front of the rectangular plates (60, 61), and there are two tooth-shaped projections (72), provided with threaded holes (73), being these aforementioned projections (72) guided by a bulge (74) on the front of the support base (71).

5. The dental articulator, according to claim 1, characterized by sets of tilting may have their bases of support (71) adjusted to different lateral positions governed by a bolt of lateral movement (76).

6. The dental articulator, according to claim 1, characterized by the arm movement (9) be comprised of a structure in a “T” shaped form, having a screw (23) inside, plug pins with beads on the end (46 , 51) and a square hole (21) in the more elongated structure.

7. The dental articulator, according to claim 1, characterized by the set of lateral-frontal motion (80) to comprise a central guide (81) formed by an elongated strip with a guide plate (82) in its rear end, having at its front end two tabs (83) with threaded guide holes, that slide through projections and are locked by screws (89), two side plates (86) in the form of a quarter circle, with a cutout (87) with numerical markings of angles along the circular edge and that end in the front, in the form of two flaps (88) with threaded holes, that slide through protruding tabs and have their movement controlled by screws and plate guides (91) connected to the side plates by a shaft located in the vertex of the side plates.

8. The dental articulator, according to claim 1, characterized by the superior and inferior positioning/repositioning sets (2, 2a) to comprise two balls (24), encapsulated in a vertical cylindrical enclosure (25), which embraces both balls (24) exposing half of one in its upper portion and the other one in its lower portion, allowing them to spin freely, without loosening them, and that the vertical cylinder (25) has a slit (half opened) and may be locked by a screw (26), preventing the rotation of the spheres, being that one of these spheres has a fixture like a rod with threaded tip, which allows its connection to the cover (10) of the support structure (1) or to the arm movement (9) through the respective locking elements and the other sphere has a small rod (28) which serves as a mechanism of union between it and a rectangular magnet (30).

9. The dental articulator, according to claim 1, characterized by the protractor to be constituted by an arc (fourth) with tips of rubber (32) at its ends and with a block (33) of rectangular shape at its center, which has a rectangular slot in its front surface and with a nosepiece (34) consisting of an element in soft material with the anatomical shape of the human nose.

10. The dental articulator, according to claim 1, characterized by the protractor to be complemented by a horizontal rod (5) consisting of a prismatic bar leaked, on which locking element (6) is fitted, and this horizontal rod (5) have scale markings along all surfaces.

11. The dental articulator, according to claim 1, characterized by a locking element (6) sliding inside the hollow horizontal rod (5), having a prismatic shape with a threaded hole in its lateral surfaces and in its top and bottom surfaces, having a square hole, to collect the set of positioning/repositioning of the arc (7) which rod is locked by a screw.

12. The dental articulator, according to claim 1, characterized by the set of positioning/repositioning of the arc (7), be constituted of two balls (24), encapsulated in a vertical cylindrical enclosure (25), which embraces both balls (24) exposing half of one in its upper portion and the other one in its lower portion, allowing them to spin freely, without loosening them, and that the vertical cylinder (25) has a slit (half opened) and may be locked by a screw (26), preventing the rotation of the spheres, being that, one of these spheres is fixed to a rod that passes through the locking element (6) and on one surface of the stem there is a marking, like a ruler for registering the reference position and the other spheres fixed to a small rod, that serves as a mechanism of union between it and a rectangular magnet (30).

13. The dental articulator, according to claim 1, characterized by the stem with nipper (8) to be a rectangular rod which has one end in a rectangular cavity (35) with the dimensions required for docking the magnet (30), and the other end is connected to an element in the shape of human dental arch.

14. Method for operation of the dental articulator for positioning the arcades being characterized by the following steps:
Taking the print of the cusps of the teeth of the patient, by pressing the impression material set in the bite fork (8), and then holding it in position in the mouth while the spatial positioning system is coupled to it at its end;
Positioning the arc of the protractor (4), so that their ends touch the face at the region where it is located the temporomandibular joint, which determines the correct alignment to Frankfurt Plane;
Locking the spatial positioning mechanism of protractor, by rotating the screw (26) of the receptacle (25) balls (24) and the locking element (6) of the set.
Detaching the horizontal rod (5) of the protractor that was embedded in the arc (fourth) and transferring to the device by inserting the rod (5) into a notch (15) provided for that purpose;
Setting the plaster model of the superior arcade, which already contains the base connector (3), to the corresponding marks of the teeth obtained in the impression material during the first step;
Adapting the magnet (30) to the cradle connector (3) of the superior model and fitting the positioning/repositioning set, adjusting the position of the vertical rod (27) and the system of spheres (24) and locking them by tightening their corresponding screws;
Removing the horizontal rod (5) of the protractor (4) to proceed with the positioning of the inferior model;
Fitting the wax plate with the marks of the correct inter-maxillary occlusion to the superior model (clinical step performed before the start of this whole procedure) so that the inferior model can be related to it;
Positioning the inferior model, that already contains the lower base connector (3) to the correspondent marks in the wax plate and fitting the magnet (30) of inferior positioning set, for the adjustment of the position of the vertical rod (27) and system of spheres (24) and locking the entire system by tightening the corresponding screws;
The movement of opening and closing of the arches is played by the opening movement of the cover (10), allowed by the hinge pin (14);
Setting the angulations of the tilting sets (17, 17a) and the frontal guide plate (81), by positioning the inferior model according to the bite wax marks obtained when the patient got the mandible in the most extremely forward position (protrusion position);
Setting the slope of the tilting sets (17.17a), right and left, until the boards with recesses touches the balls in the ends of protruding pins (46);
Fitting the central guide by leaning the guide plate (82) until it touches the pin (51) that fits in the most elongated arm movement;
Locking up all the positions by tightening the screws (45.85);
The movement of protrusion is reproduced by walking the arm movement over the plates with recesses and center tab so adjusted;
Adjusting the lateral movements by positioning the inferior model, connected to the arm movement (9) to correspondent marks of the teeth obtained in a wax plate during the procedure that the patient led his mandible to the most extremely lateral position to the left side and then doing the same to the right side with another wax plate;
Leading the arm movement to the right, so the ball of the pin (51) will be partially retained within the guide plate (91), determining a lateral inclination of the plate;
Locking this position by tightening the screw (89) that is connected to the lateral plate through the threaded holes;
To adjust the left side, the same sequence of procedures must be repeated, using the wax bite corresponding to this side;
After this settings, it is possible to accurately reproduce the protrusion and lateral mandibular movements by sliding the arm movement (9) through the guides;
To start the movement is necessary to make slight pressure on the spring (100) attached to the pin (51) of the anterior region of arm movement (9), allowing the beads from the ends of protruding pins (46) to rotate about their own centers promoting a slight detachment between the arcades, freeing the movement.
